(19) United States
(12) Patent Application Publication
(10) Pub. No.: US 2022/0339810 A1
(43) Pub. Date: Oct. 27, 2022

(54) BOLT CUTTING APPARATUS

(71) Applicant: Team Industrial Services, Inc., Sugar Land, TX (US)

(72) Inventors: Mark KING, Cumbria (GB); Jimi WADE, Cumbria (GB); Oliver EVANS, Cumbria (GB)

(21) Appl. No.: 17/762,574

(22) PCT Filed: Sep. 22, 2020
(86) PCT No.: PCT/US2020/051957

§ 371 Date: Mar. 22, 2022

Related U.S. Application Data
(60) Provisional application No. 62/904,043, filed on Sep. 23, 2019.

(51) Int. Cl. B26D 1/18

(52) U.S. Cl. CPC B26D 1/18

(57) ABSTRACT

A bolt cutting apparatus including a cutter assembly and a carriage assembly attached to the cutter assembly. The carriage assembly includes a carriage housing, a tool post coupled to the carriage housing, a motor attached to the tool post, and a drive assembly configured to linearly move the tool post. The carriage assembly is configured to be secured to a structure, e.g. a flange. A cutter is attached to the motor and is disposed in the carriage housing. The motor is configured to rotate the cutter to cut a bolt on the structure, e.g. flange.

### CROSS-REFERENCE TO RELATED APPLICATION

The present document is based on and claims priority to U.S. Provisional Application Ser. No. 62/904,043, filed Sep. 23, 2019, which is incorporated herein by reference in its entirety.

### FIELD OF DISCLOSURE

In general, the disclosure describes an apparatus for cutting bolts, and more particularly, an apparatus for cutting flange bolts.

### BACKGROUND OF DISCLOSURE

Flange assemblies may be used in process and plant pipework to connect pipes and other tubulars. The flange assemblies include two flanges and flange fasteners, such as bolts, to connect the two flanges together to join the tubulars together. Sometimes, there may be a need to disconnect the flanges to separate the tubulars. However, the flange bolts may have corroded preventing disconnection of the flanges by a tool otherwise used to loosen the flange bolts. Although torches have sometimes been used to cut flange bolts, such “hot work” can be damaging or difficult to perform. In some environments, the hot work approach requires special permits which can be difficult to obtain and may involve a lengthy permitting process.

What is needed is an improved bolt cutting apparatus for cutting flange bolts that connect tubulars together.

### SUMMARY

This summary is provided to introduce a selection of concepts that are further described below in the detailed description. However, many modifications are possible without materially departing from the teachings of this disclosure. Accordingly, such modifications are intended to be included within the scope of this disclosure as defined in the claims. This summary is not intended to identify key or essential features of the claimed subject matter, nor is it intended to be used as an aid in limiting the scope of the claimed subject matter.

An embodiment of the present disclosure provides a bolt cutting apparatus including a cutter assembly and a carriage assembly attached to the cutter assembly. The carriage assembly includes a carriage housing, a tool post coupled to the carriage housing, a motor attached to the tool post, and a drive assembly configured to linearly move the tool post. The carriage assembly is configured to be secured to a flange. A cutter is attached to the motor and is disposed in the carriage housing. The motor is configured to rotate the cutter to cut a bolt on the flange.

An embodiment of the present disclosure provides a method of cutting a bolt on a flange, including securing a carriage assembly to the flange with a strap and attaching a cutter assembly to the carriage assembly. The cutter assembly encloses a cutter in a retracted position. The method further includes rotating a drive handle to linearly move the cutter to cut the bolt.

### BRIEF DESCRIPTION OF THE FIGURES

Certain embodiments of the disclosure will hereafter be described with reference to the accompanying drawings, wherein like reference numerals denote like elements. It is emphasized that, in accordance with standard practice in the industry, various features are not drawn to scale. In fact, the dimensions of various features may be arbitrarily increased or reduced for clarity of discussion. It should be understood, however, that the accompanying figures illustrate the various implementations described herein and are not meant to limit the scope of various technologies described herein, and:

FIG. 1 is a side perspective view of a bolt cutting apparatus having a cutter assembly of a first embodiment and engaged on a flange in a horizontal orientation;

FIG. 2 is a side perspective view of a bolt cutting apparatus having a cutter assembly of a second embodiment and engaged on a flange in a horizontal orientation;

FIG. 3 is an exploded view of a cutter housing top and a cutter in accordance with embodiments of the present disclosure;

FIG. 4 is a top perspective view of a cutter assembly of the bolt cutting apparatus showing cutter retractable guards in a retracted position in accordance with embodiments of the present disclosure;

FIG. 5 is a top perspective view of the cutter assembly disconnected from a carriage assembly and showing the cutter retractable guards in an extended position in accordance with embodiments of the present disclosure;

FIG. 6 is a top perspective view of the carriage assembly disconnected from the cutter assembly in accordance with embodiments of the present disclosure;

FIG. 7 is a top perspective view of one embodiment of a bolt cutting apparatus engaged on a flange in accordance with embodiments of the present disclosure;

FIG. 8 is a top perspective view of the bolt cutting apparatus engaged on a flange and showing the cutter retractable guards in an extended position in accordance with embodiments of the present disclosure;

FIG. 9 is a top perspective view of the bolt cutting apparatus of FIG. 8 and showing the cutter retractable guards in a retracted position in accordance with embodiments of the present disclosure;

FIG. 10 is a front perspective view of the bolt cutting apparatus in accordance with embodiments of the present disclosure;

FIG. 11 is a top perspective view of a cross-section of the carriage assembly secured on a flange in accordance with embodiments of the present disclosure;

FIG. 12 is a side perspective view of a portion of the carriage assembly engaged on a flange and showing a flange engagement apparatus in accordance with embodiments of the present disclosure;

FIG. 13 is a bottom view of a portion of the carriage assembly engaged on a flange and showing the flange engagement apparatus engaging a bottom surface of the flange in accordance with embodiments of the present disclosure;

FIG. 14 is a side perspective view of a cross-section of the carriage assembly and showing a tool post in accordance with embodiments of the present disclosure;

FIG. 15 is a side perspective view of a cross-section of the carriage assembly and showing a tool post drive assembly in accordance with embodiments of the present disclosure;

FIG. 16 is a side perspective view of a drive handle attached to a drive rod of the carriage assembly in accordance with embodiments of the present disclosure;

FIG. 17 is an exploded view of a bottom plate and a motor in accordance with embodiments of the present disclosure;

FIG. 18 is a partial, top perspective view of the bolt cutting apparatus engaged on a flange in a vertical orientation in accordance with embodiments of the present disclosure;

FIG. 19 is a cross-sectional view of the bolt cutting apparatus showing a motor connected to the cutter in accordance with embodiments of the present disclosure; and

FIGS. 20-22 are a series of perspective views of the bolt cutting apparatus secured to a flange and showing the cutter cutting a bolt on the flange in accordance with embodiments of the present disclosure.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements.

According to an embodiment, a bolt cutting apparatus is provided which facilitates the quick and easy cutting and removal of bolts, e.g. flange bolts. The bolt cutting apparatus may include a cutter assembly and a carriage assembly attached to the cutter assembly. In some embodiments, the cutter assembly and carriage assembly are modular so that different cutter assemblies may be mounted to the carriage assembly. The carriage assembly may comprise a carriage housing, a tool post coupled to the carriage housing, a motor, e.g. a hydraulic motor, attached to the tool post, and a drive assembly configured to linearly move the tool post. The carriage assembly is configured to be secured to a flange or other suitable structure. A cutter may be attached to the motor and disposed in the carriage housing. The motor is configured to rotate the cutter to cut a bolt, e.g. a bolt located on a flange. According to an embodiment, the carriage assembly may be secured to a flange with a strap. The cutter assembly is attached to the secured carriage assembly and encloses a cutter in a retracted position. A drive handle may be operated to linearly move the cutter to cut the bolt.

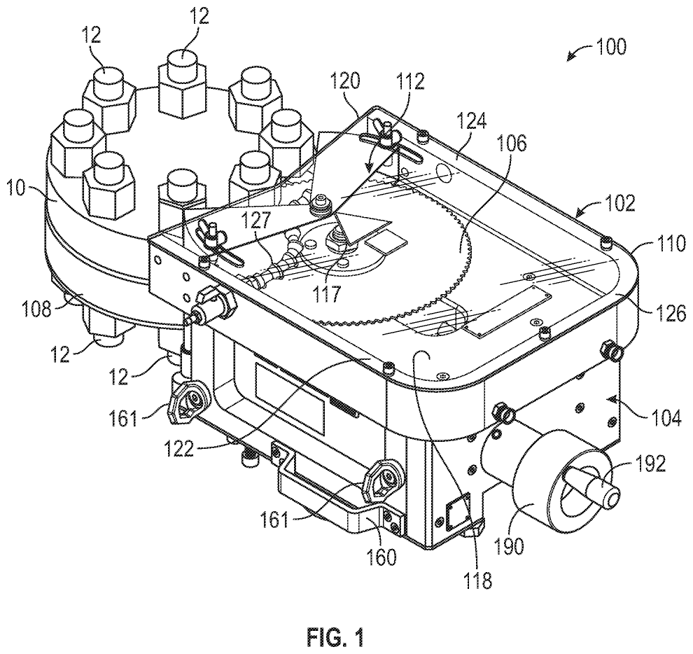

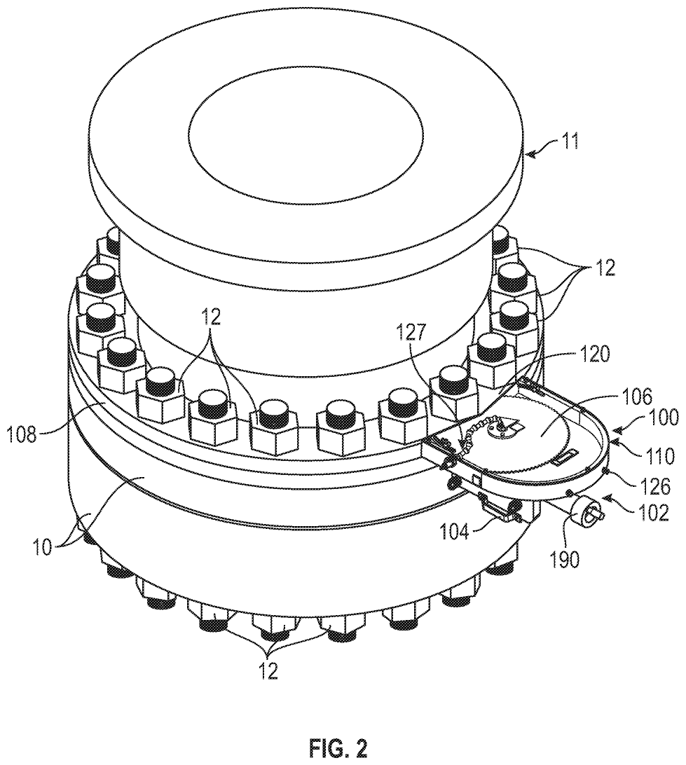

Referring generally to FIG. 1 and FIG. 2, embodiments of a bolt cutting apparatus 100 are illustrated as operatively engaged in a horizontal orientation about two flanges 10 of a tubular structure 11, the flanges 10 being connected by flange bolts 12. In the illustrated embodiment, a ratchet strap 108 may be used to secure the bolt cutting apparatus 100 to the flange 10, however other types of securing mechanisms may be utilized for flanges or other types of tubular structures. Bolt cutting apparatus 100 includes a cutter assembly 102, a carriage assembly 104, and a cutter 106 formed by a circular cutter or other suitable cutter. Cutter assembly 102 is detachably attached to the carriage assembly 104. The bolt cutting apparatus 100 may be constructed as a modular cutter in which cutter assembly 102 is detachable to allow for different cutter assemblies 102 to be mounted to carriage assembly 104. Different cutter assemblies 102 may be configured for different cutter sizes and different flange sizes while being releasably engageable with the same carriage assembly 104. Examples of different cutter assemblies 102 include a first embodiment, as shown in FIG. 1, and a second embodiment, as shown in FIG. 2. Cutter assembly 102 of the first embodiment may be configured for a cutter 106 having a smaller diameter dimension, e.g. a 250 mm diameter dimension. Cutter assembly 102 of the second embodiment may be configured for a cutter 106 having a larger diameter dimension, e.g. a 425 mm diameter dimension.

As illustrated, cutter assembly 102 includes a cutter housing 110 and a cutter retractable guard assembly 112. Cutter housing 110 is configured to enclose the cutter 106. Cutter housing 110 may have a cutter housing bottom 118 and a cutter housing top 120 disposed opposite one another. In some of the Figures, e.g. FIG. 1 and FIG. 2, cutter housing top 120 is shown to be transparent to illustrate the cutter 106 housed in the cutter housing 110. Cutter housing top 120 is configured to cover at least a portion of the top of the cutter 106. In the embodiment illustrated, cutter assembly 102 includes a first cutter housing side 122, a second cutter housing side 124 opposite the first cutter housing side 122, and a back cutter housing side 126. Cutter housing 110 may have different shapes. In the embodiment shown in FIG. 1, for example, the back cutter housing side 126 has a portion that is straight. In the embodiment shown in FIG. 2, the back cutter housing side 126 has a curved shape.

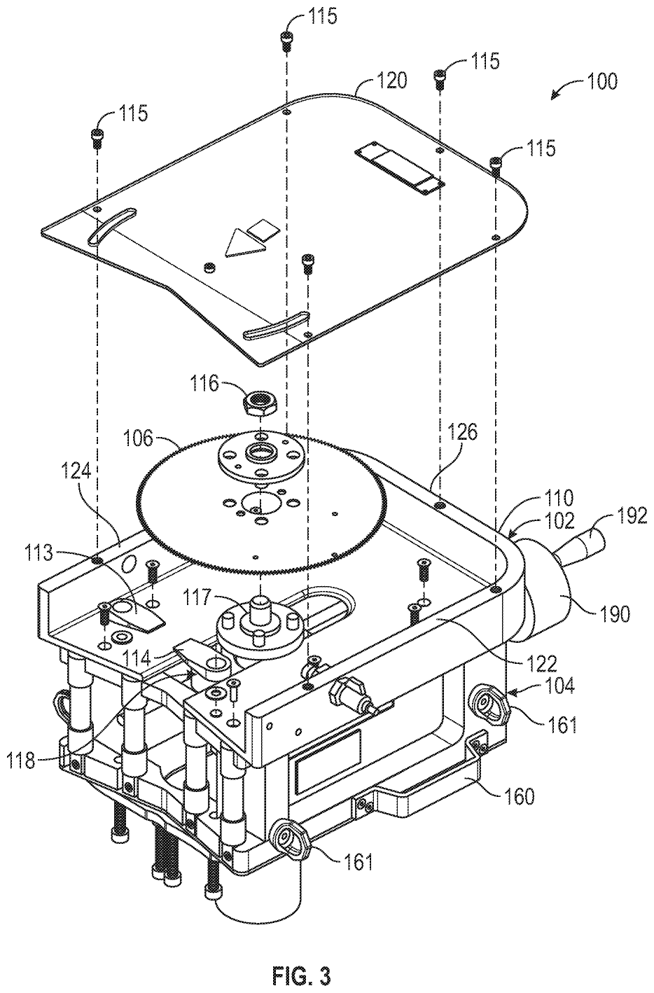

Referring generally to FIG. 3, an exploded view of an embodiment of the bolt cutting apparatus 100 is shown with the cutter housing top 120 and cutter 106 detached from the cutter housing 110. Cutter housing top 120 is attached to the cutter housing 110 with bolts 115. Cutter 106 may be attached with a nut 116 to a drive spindle 117 extending through a slot 119 in the cutter housing bottom 118. A pair of location arms 113, 114 may be attached to cutter housing bottom 118. A mechanical fastener, such as a cap screw, may be used to pivotally attach the location arms 113, 114 to the cutter housing bottom 118. Location arms 113, 114 are shown in a retracted position in FIG. 3. Location arms 113, 114 may be positioned in an extended position to help secure the bolt cutting apparatus 100 to, for example, flanges 10 (see location arm 114 in the extended position in FIG. 12). Location arms 113, 114 may be adjusted against atop surface of the top flange 10 when the bolt cutting apparatus 100 is secured to the flange to help prevent movement of the cutter assembly 102 and the carriage assembly 104 during an operation to cut a bolt on the flange.

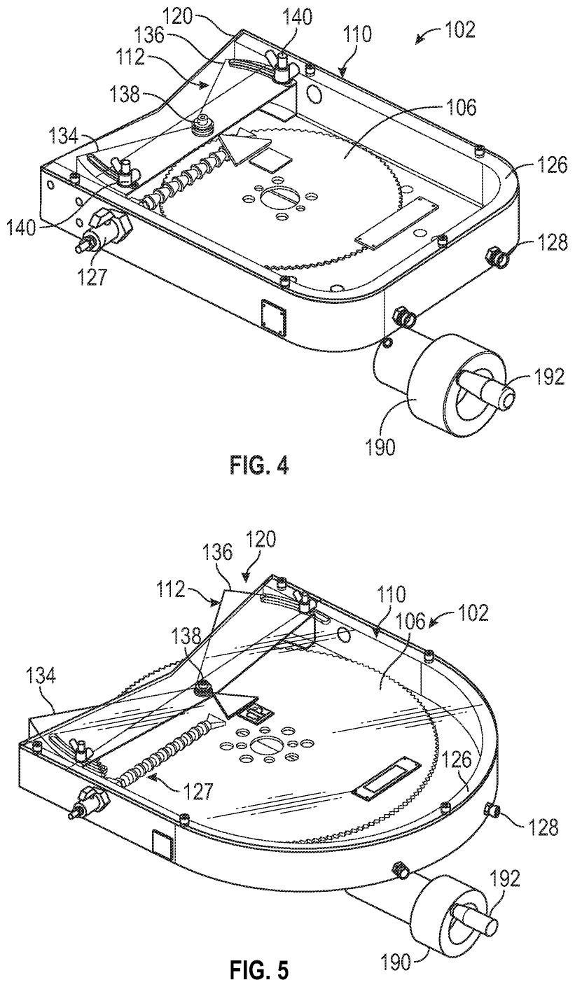

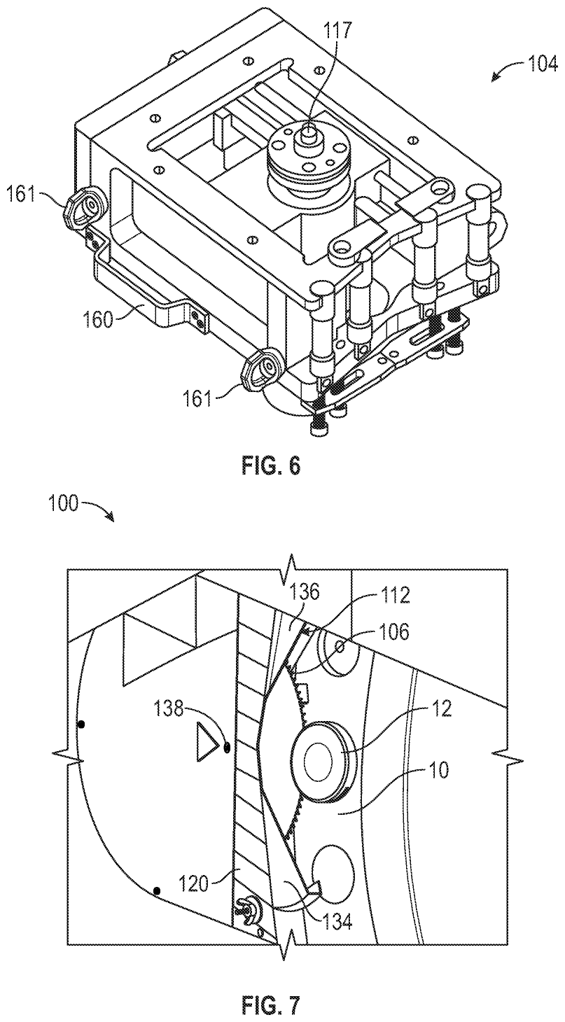

Referring generally to FIG. 4 and FIG. 5, cutter assembly 102 is shown in an unattached position where the cutter assembly 102 is detached from the carriage assembly 104. Bolt cutting apparatus 100 is configured to be modular, including configuring cutter assembly 102 to be detached and/or attached using mechanical fasteners, such as bolts. The cutter assembly 102 may have different embodiments configured for cutters 114 of different diameters. Cutter assembly 102, shown in FIG. 4, shows one embodiment of the cutter assembly 102 where the cutter 106 has a first diameter. Cutter assembly 102, shown in FIG. 5, shows another embodiment of the cutter assembly 102 where the cutter 106 has a second diameter. The first diameter may be greater than the second diameter. Referring to FIG. 6, carriage assembly 106 is shown in the unattached position where the carriage assembly 106 is separate from the cutter assembly 102.

With additional reference to FIGS. 4 and 5, cutter assembly 102 is illustrated as including a lubricant apparatus 127 for directing lubricant onto the cutter 106 and in the cutter housing 110. Lubricant apparatus 127 may be formed by a tube that extends through the cutter assembly housing 110 between the cutter 106 and the cutter housing top 120. A coolant connector 128 also may be positioned to extend through the cutter housing 110 and may be configured to drain lubricant from the cutter housing 110.

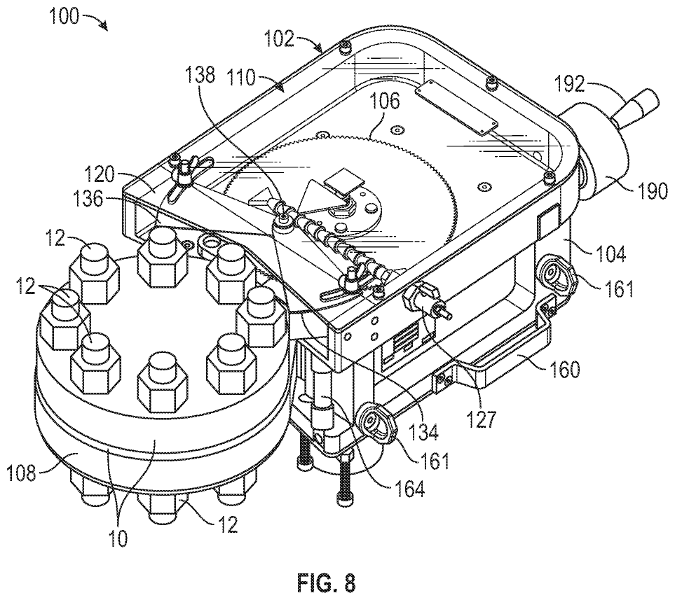

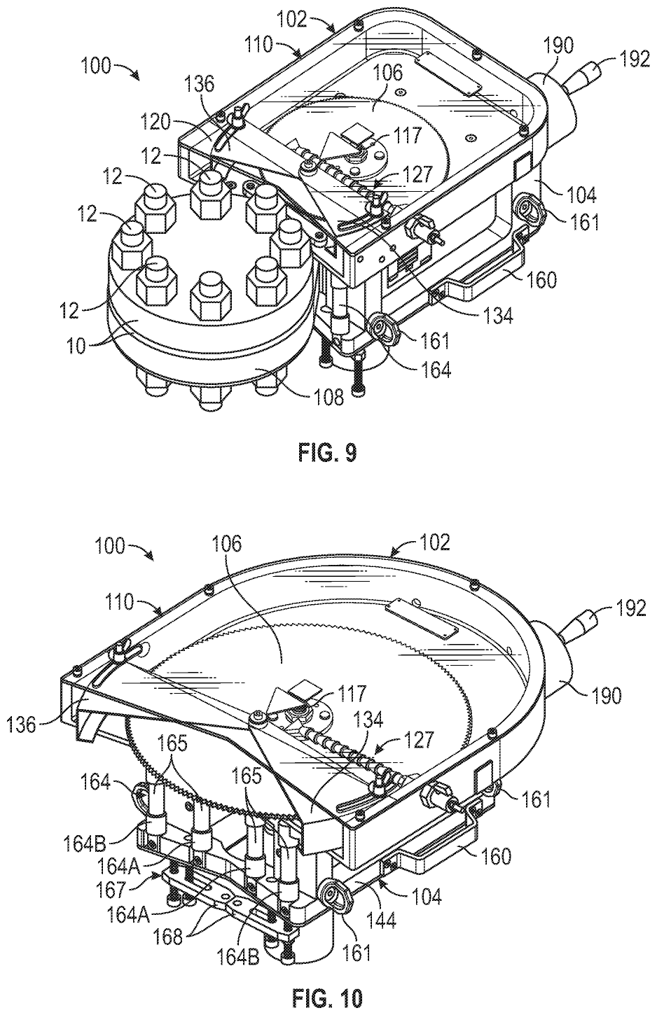

Cutter retractable guard assembly 112 may include a first cutter retractable guard 134 and a second retractable guard 136 coupled together at a pivot attachment 138. Cutter retractable guards 134, 136 are configured to be moved between a guard retracted position and a guard extended position. When in the guard retracted position, the cutter retractable guards 134, 136 are fully covered by the cutter housing top 120. When in the guard extended position, at least a portion of the cutter retractable guards 134, 136 are extended outwardly from the cutter housing top 120. Pivot attachment 138 may be formed by a socket head cap screw and is attached to the cutter housing top 120. Cutter retractable guards 134, 136 rotate at the pivot attachment 138 between the guard retracted position and the guard extended position. A mechanical fastener 140 may be used to lock each of the cutter retractable guards 134, 136 in a selected position between the guard retracted position and the guard extended position. By way of example, the mechanical fastener 140 may be in the form of a wingnut or other suitable fastening nut. Cutter retractable guards 134, 136 are shown in the extended position in FIG. 7 and FIG. 8 while the bolt cutting apparatus 100 is engaged on a flange or flanges 10. The cutter retractable guards 134, 136 provide a block to the cutting area to provide a safety feature. Cutter retractable guards 134, 136 are shown in a retracted position in FIG. 9 while the bolt cutting apparatus 100 is engaged on flange(s) 10.

Referring generally to FIGS. 10-19, carriage assembly 104 is illustrated as having a carriage housing 144 and a tool post carrier assembly 146. Carriage housing 144 includes a first carriage side 150, a second carriage side 152 opposite the first carriage side 150, a back carriage side 154, and a front carriage side 156. A carry handle 160 is attached on each of the carriage sides 150, 152. A plurality of load rings 161 formed by lifting eyes may be attached to each of the carriage sides 150, 52.

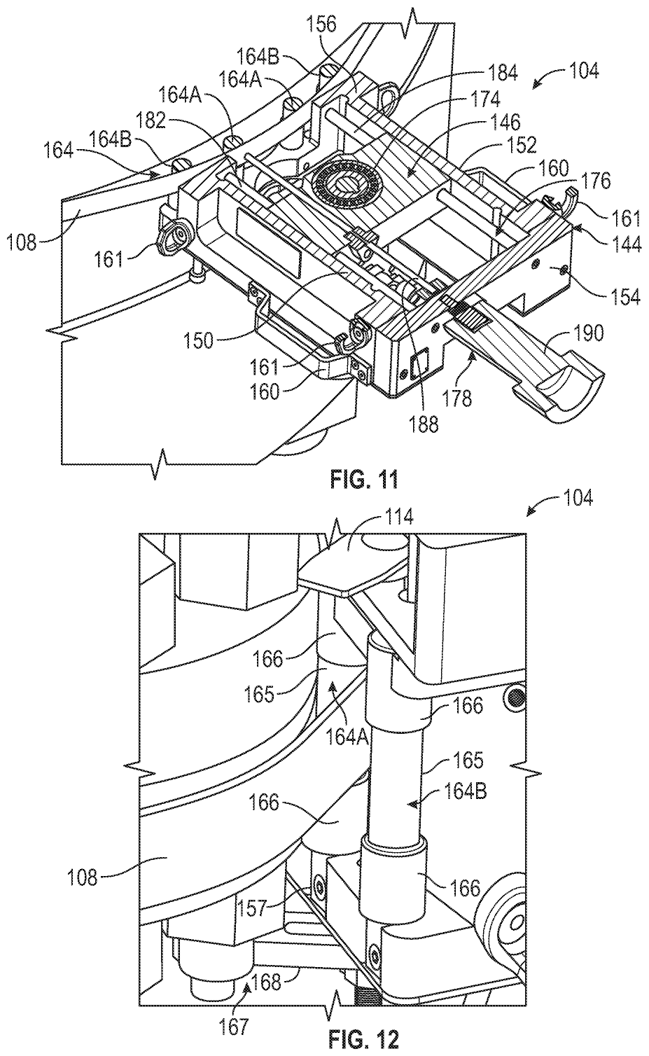

In this example, carriage housing 144 further includes a plurality of pins 164 secured on the carriage housing 144 at the front carriage side 156. Pins 164 include inner pins 164A and outer pins 164B outwardly offset from the inner pins 164A. Referring to FIG. 12, each pin 164 may be constructed with flange engagement sections 166 at a top portion and a bottom portion of the pin 164 and a strap engagement section 165 between the top portion and the bottom portion. Engagement sections 166 have an outer diameter greater than the strap engagement sections. Engagement sections 166 may also be configured with protrusions, such as spikes, to deform and grip the flange when the carriage housing 144 is secured to the flange. Ratchet strap 108 is engaged with the inner pins 164A in the embodiment shown in FIG. 12. Ratchet strap 108 may be an endless ratchet strap. Inner pins 164A may engage the ratchet strap 108 when the bolt cutting apparatus is being engaged with a flange at a first flange diameter, as shown in FIG. 12. Outer pins 164B may engage the ratchet strap 108 when the bolt cutting apparatus 100 is being engaged with a flange at a second flange diameter, see FIG. 11. In this example, the first flange diameter is less than the second flange diameter.

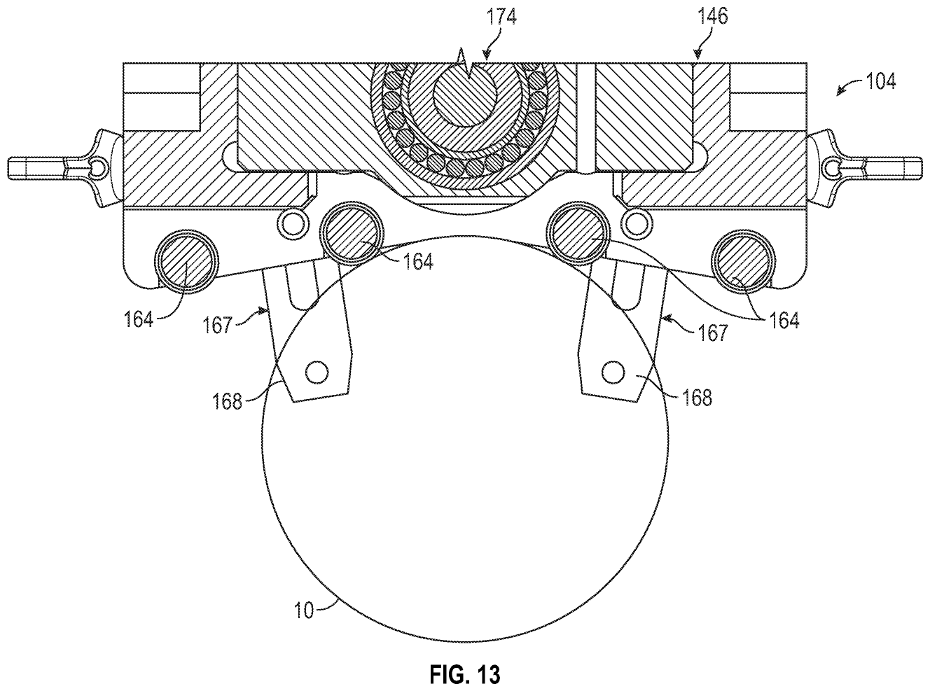

Carriage housing 144 may include an attachment footing apparatus 167, as shown in FIG. 10, FIG. 12, and FIG. 13. The attachment footing apparatus 167 is attached to a bottom of the carriage housing 144. Attachment footing apparatus 167 may include a pair of attachment feet 168 attached to the bottom of the carriage housing. Attachment feet 168 may be rotated under a flange surface and pressed against the flange surface to help secure the carriage housing 144 to the corresponding flange 10 when the carriage housing 144 is secured to the flange, see FIG. 12 and FIG. 13 showing attachment feet 168 disposed below a surface of the flange.

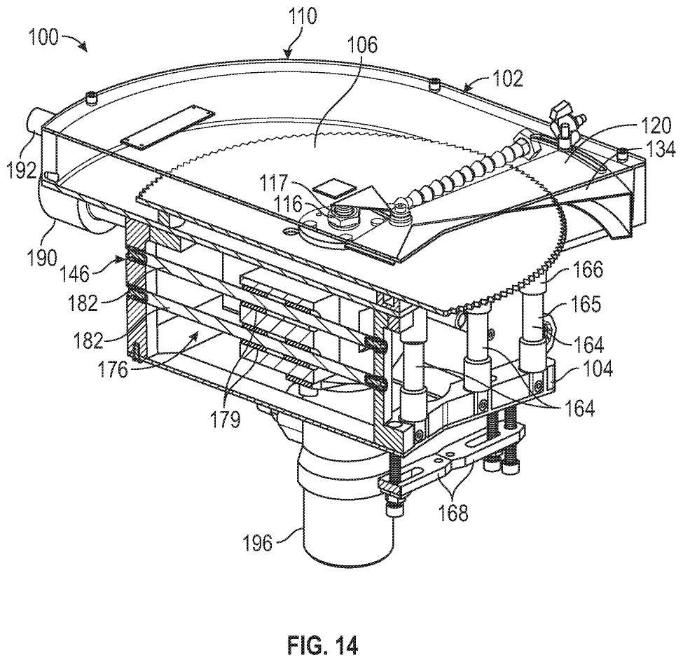

Tool post carrier assembly 146 may include a tool post 174, a rail assembly 176, and a tool post drive assembly 178, as shown in FIG. 11. Tool post 174 is supported by rail assembly 176 and is linearly moveable on the rail assembly 176 with the carriage housing 144. Tool post 174 is configured to move from adjacent the back carriage side 154 to the front carriage side 156 on the rail assembly 176. Rail assembly 176 has first rail 182 and a second rail 184 parallel to the first rail 182. Rails 182, 184 extend through the tool post 174 and the tool post 174 slides on the rails 182, 184. Tool post 174 may have bearings 179 that engage with the rails 182, 184 to allow for sliding of the tool post 174 on the rails 182, 184, as shown in FIG. 14.

Tool post drive assembly 178 drives the tool post 174 to linearly move the tool post 174 on the rail assembly 176. Tool post drive assembly 178 may include a drive rod 188 and a drive handle 190. In the illustrated example, drive handle 190 extends outwardly from the back carriage side 154 and has a handwheel revolving grip 192, see FIG. 9, attached to the drive handle 190. Drive handle 190 has a cylindrical shape and the handwheel revolving grip 192 is attached on an outer end of the drive handle 190 and is disposed off-center on the drive handle 190.

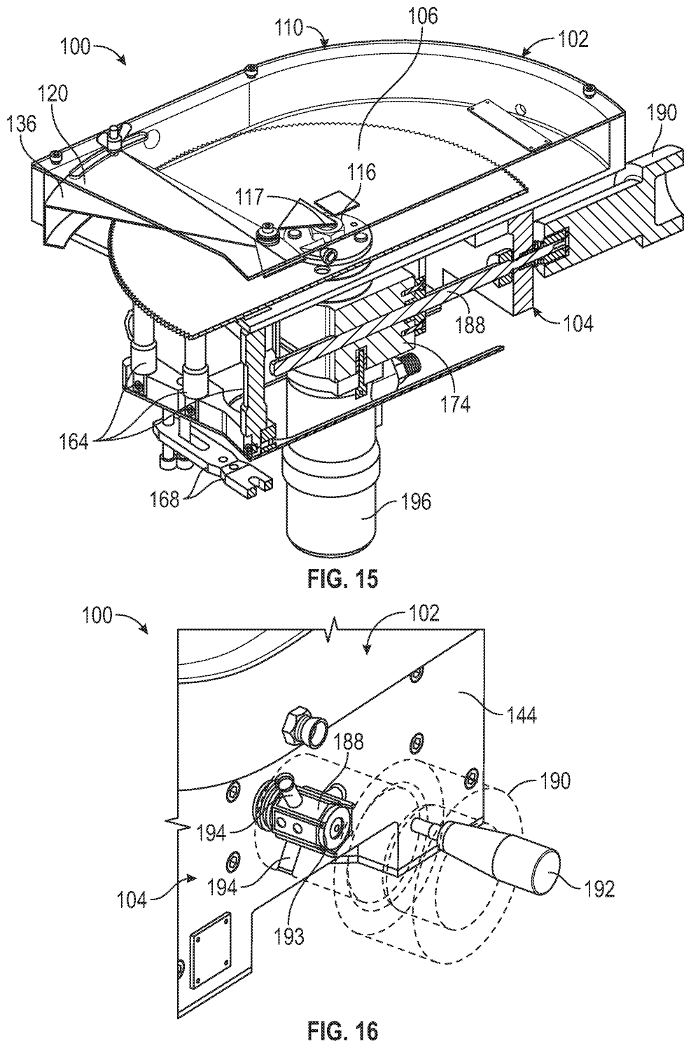

Drive handle 190 is configured to rotate the drive rod 188 and as the drive rod 188 rotates the tool post 174 is driven on the rail assembly 176, see FIG. 15. Drive rod 188 has drive rod threads that engage tool post threads. As the drive rod 188 is rotated in one direction the tool post 174 moves forward linearly and as the drive rod 188 is rotated in the opposite direction the tool post 174 moves backward linearly.

Drive handle 190 may be removable from the carriage housing 144. Carriage assembly 102 may include a handle adaptor 193 for removably attaching drive handle 190 to the carriage assembly 102. Drive handle 190 may attach to the handle adapter 193 with pins 194 that extend through pin slots in the drive handle 190 and into a pin slot in the handle adapter 193, see FIG. 16. The pins may be spring biased in the pin slot of the handle adapter 193 to allow for easy detachment of the drive handle 190.

The bolt cutting apparatus 100 may be powered by a motor 196, e.g. a hydraulic motor, a pneumatic motor, or an electric motor. In the illustrated example, motor 196 is a hydraulic motor. As illustrated, cutter 106 may be housed in the cutter housing 110. Motor 196 is coupled to the cutter 106 for rotatably driving cutter 106. In this example, motor 196 is a direct drive motor which is hydraulically powered although other types of motors may be employed.

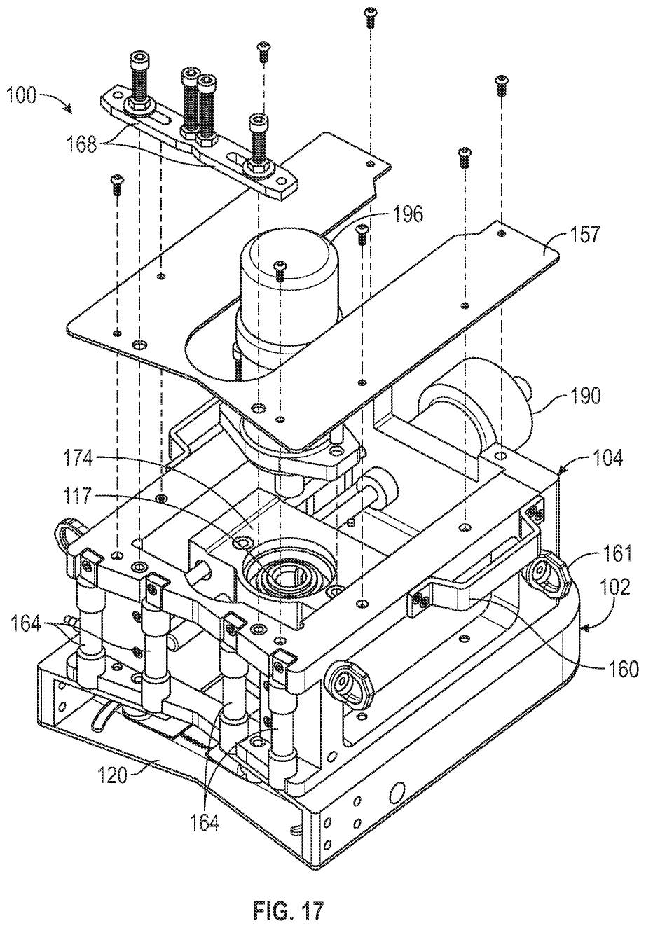

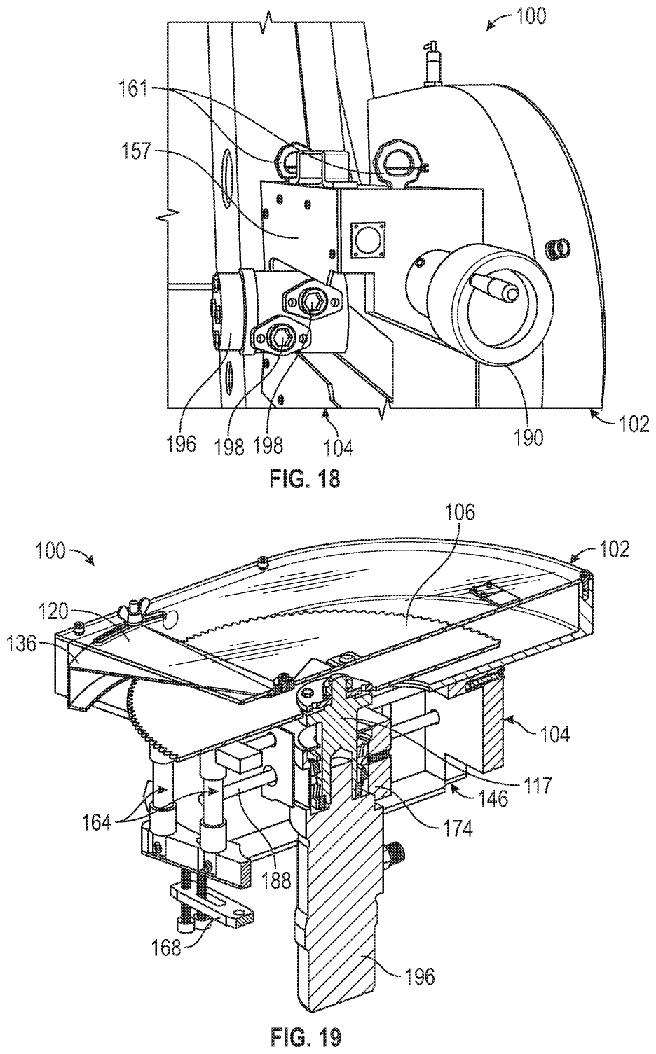

An exploded view of the motor 196 and a bottom plate 157 is shown from a bottom side perspective in FIG. 17. Motor 196 may be directly attached to the cutter 106 to rotate the cutter 106, however motor 196 could be attached to cutter 106 via gears or other mechanisms. Bottom plate 157 may have a channel configure for the motor 196 to linearly move within the channel as the tool post 174 moves the cutter 106. Bolt cutting apparatus 100 in the assembled position and secured to a flange 10 in a vertical orientation is shown in FIG. 14. Motor 196 extends from the bottom plate 157. Hose connectors 198 in motor 196 may be attached to hoses or other fluid conduits which, in turn, are coupled to a fluid source (see FIG. 18) which supplies fluid to the motor 196. In FIG. 19, an embodiment of motor 196 is illustrated as coupled directly to the cutter 106.

In operation, an operator secures the bolt cutting apparatus 100 to a flange via, for example, ratchet strap 108. Bolt cutting apparatus 100 is configured to be modular to allow for easier handling and securing to flange 10 by an operator. Carriage assembly 104 and cutter assembly 102 may be separate, i.e. unattached, before the operator secures the carriage assembly 104 to a flange 10. The carriage assembly 104 alone may be easier for an operator to handle manually when connecting the carriage assembly 104 to a flange. For example, an operator may use the carry handles 160 to lift and secure the carriage assembly 104 in a horizontal orientation or a vertical orientation on the flange 10. The carriage assembly 104 may have a weight that allows one operator and/or two operators to manually install the carriage assembly 104 on a flange 10. In some applications, bolt cutting apparatus 100 may be attached to flange 10 while the carriage assembly 104 and cutter assembly 102 are connected together. In such applications, lifting equipment may be employed to facilitate lifting and attachment of the overall bolt cutting apparatus 100.

For example, a crane or other lifting equipment may sometimes be utilized to lift and secure the carriage assembly 104 to the flange. In some applications, lifting equipment may be coupled to the carriage assembly 104 using the load rings 161, e.g. lifting eyes, on the carriage assembly 104. Ratchet strap 108 is then wrapped around the flange and through pins 164, e.g. a pair of the pins 164. The ratchet strap 108 may be tightened with a standard ratchet mechanism to tighten the ratchet strap 108 and secure the pins 164 against the flange. Attachment footing apparatus 167 may also be tightened to secure the carriage assembly to the flange.

After the carriage assembly 104 is secured to the flange 10, the cutter assembly 102 is attached to the carriage assembly 104 (assuming the cutter assembly 102 and carriage assembly 104 have not been mounted as a combined unit). Depending on the application, certain embodiments of bolt cutting apparatus 100 may have a weight of 44 kg to 53 kg. Cutter retractable guards 134, 136 may be placed in the extended guard position to provide a safety block for a cutting area proximate the cutter 106. If motor 196 is a hydraulic motor, fluid hoses (not shown) are coupled to the motor 196 to provide a fluid medium to drive the motor 196 and thus the cutter 106.

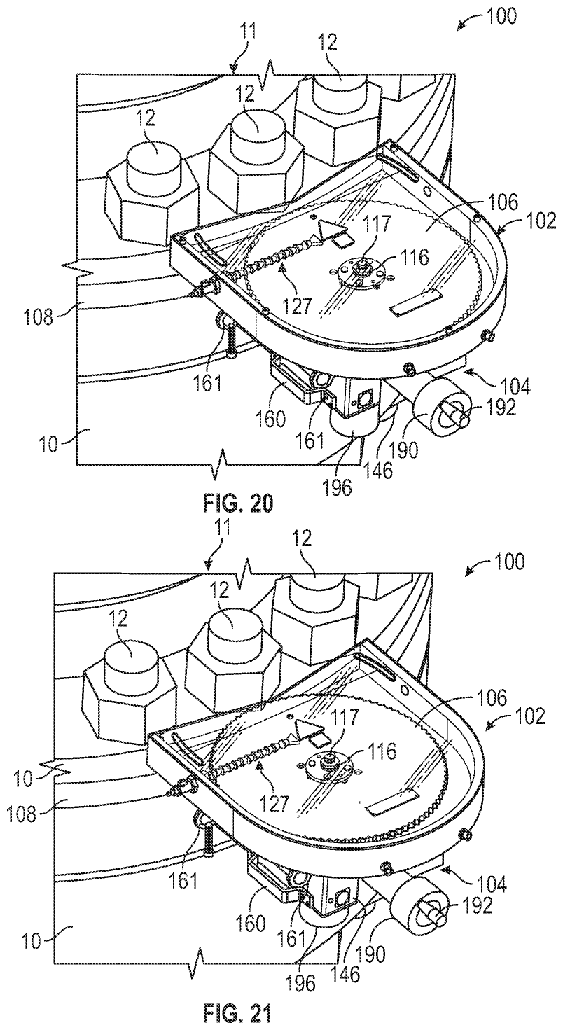

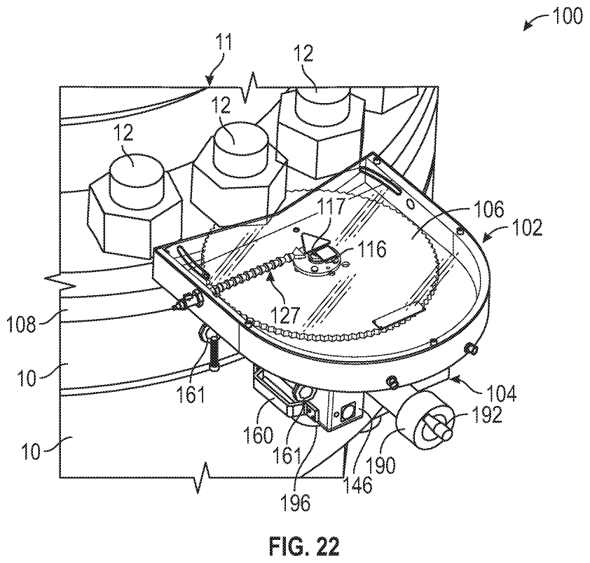

Tool post drive assembly 178 is used to linearly move the cutter 106 to cut a bolt on the flange. Cutter 106 may start in a retracted position, as shown in FIG. 20. Tool post drive assembly 178 is used to feed the cutter 106 forward to cut the bolt on the flange. An operator rotates the drive handle 190 in an appropriate direction, e.g. counter-clockwise, to feed the cutter 106 forward to engage the bolt, as shown in FIG. 21. The operator continues to rotate the drive handle 190 in this counter-clockwise direction to thus feed the cutter 106 in a linear direction to continue to cut the bolt, as shown in FIG. 22. The operator continues feeding the cutter 106 forward until the bolt is cut. The operator may rotate the drive handle in an opposite direction, e.g. a clockwise direction, to linearly move the cutter 106 back in the cutter housing 110 and place the cutter 106 in the retracted position. This cutting action may be performed on the desired number of bolts to enable the desired servicing/repair operation. It should be noted the manual drive handle 190 may be replaced with an automated, powered driver.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. A bolt cutting apparatus comprising:
a cutter assembly;
a carriage assembly attached to the cutter assembly, the carriage assembly including:
a carriage housing;
a tool post coupled to the carriage housing;
a motor attached to the tool post;
a drive assembly configured to linearly move the tool post, wherein the carriage assembly is configured to be secured to a flange; and
a cutter attached to the motor and disposed in the cutter assembly; wherein the motor is configured to rotate the cutter to cut a bolt on the flange.

2. The bolt cutting apparatus as recited in claim 1, wherein the cutter comprises a circular blade.

3. The bolt cutting apparatus as recited in claim 1, wherein the cutter assembly comprises a cutter housing sized to enclose the cutter.

4. The bolt cutting apparatus as recited in claim 3, wherein the cutter housing comprises a cutter housing top configured to cover at least a portion of the cutter.

5. The bolt cutting apparatus as recited in claim 1, wherein the carriage assembly is secured to the flange via a ratchet strap.

6. The bolt cutting apparatus as recited in claim 1, wherein the carriage assembly is secured to the flange via attachment feet.

7. The bolt cutting apparatus as recited in claim 1, wherein the cutter assembly comprises retractable cutter guards.

8. The bolt cutting apparatus as recited in claim 1, wherein the motor is a hydraulic motor.

9. The bolt cutting apparatus as recited in claim 1, wherein the cutter assembly is detachably mounted to the carriage assembly to facilitate mounting of the carriage assembly to the flange prior to mounting the cutter assembly to the carriage assembly.

10. The bolt cutting apparatus as recited in claim 1, wherein the drive assembly comprises a manually operated drive handle which may be rotated to linearly move the tool post.

11. A system for cutting bolts located along a tubular structure, comprising:
a carriage assembly configured for releasable mounting to the tubular structure;
a cutter assembly detachably connectable to the carrier assembly to form a modular structure enabling initial mounting of the carrier assembly to the tubular structure and subsequent mounting of the cutter assembly to the carriage assembly;
a cutter mounted in the cutter assembly; and
a motor connected to the cutter to rotate the cutter during a bolt cutting operation, the cutter being movable, via the carriage assembly, during the bolt cutting operation to provide a controlled cut through at least one bolt.

12. The system as recited in claim 11, wherein the cutter comprises a circular blade.

13. The system as recited in claim 11, wherein the carriage assembly is secured to the tubular structure via a ratchet strap.

14. The system as recited in claim 11, wherein the carrier assembly is configured to mount to at least one flange forming part of the tubular structure.

15. The system as recited in claim 11, wherein the cutter assembly comprises retractable cutter guards.

16. The system as recited in claim 11, wherein the motor is a hydraulic motor.

17. The system as recited in claim 11, wherein the carriage assembly comprises a tool post coupled to the motor and to the cutter, the tool post being linearly movable via a drive assembly.

18. A method of cutting a bolt on a flange, comprising:
securing a carriage assembly to the flange with a strap;
attaching a cutter assembly to the carriage assembly, wherein the cutter assembly encloses a cutter in a retracted position;
rotating a drive handle to linearly move the cutter to cut the bolt.

19. The method as recited in claim 18, further comprising coupling a motor with the cutter to power the cutter for cutting the bolt.

20. The method as recited in claim 19, wherein coupling the motor comprises operatively coupling a hydraulic motor with the cutter.
